(19) United States
(12) Patent Application Publication
(10) Pub. No.: US 2004/0053764 A1
(43) Pub. Date: Mar. 18, 2004

(54) Toroidal air bag folding apparatus

(75) Inventors: Brian C. Ford, Mt. Clemens, MI (US); Lawrence R. Langbeen, Attica, MI (US)

Correspondence Address: KEY SAFETY SYSTEMS, INC., PATENT DEPARTMENT, 7000 NINETEEN MILE ROAD, STERLING HEIGHTS, MI, 48314, US

(73) Assignee: Breed Automotive Technology, Inc.

(21) Appl. No.: 10/242,218

(22) Filed: Sep. 12, 2002

(51) Int. Cl. B31F 7/00

(52) U.S. Cl. 493/449

(57) ABSTRACT

The folding apparatus includes a ram apparatus movable through the tube and adapted to hold and move a ram plate and air bag through the tube. When moved in one direction, the ram apparatus moves the air bag into the cover. The folding apparatus further contains a movable piston which functions as an interior cushion support and is passed through a hole in the air bag module cover. The folding apparatus additionally includes a holding fixture for orienting the cover so that its internal cavity is in alignment with and adjacent to the tube such that the housing and air bag can be rammed into the cover internal cavity.

### BACKGROUND AND SUMMARY OF THE INVENTION

The present invention generally relates to a machine and method of folding or compacting an air bag and more particularly a machine and method for compacting an air bag directly into its deployment cover.

A driver side air bag module often includes a cover, housing, air bag, a cushion retainer and inflator. The typical way of assembling an air bag module is to insert the retainer within the central opening of the air bag and then to mount the retainer and air bag to the housing. Thereafter, the air bag is precisely folded into the housing. Subsequently, the cover is attached to the housing. As a final step in the manufacturing process, the inflator is inserted and secured to the housing. The prior art has also proposed to fold an air bag in an arbitrary or chaotic manner and then take this folded air bag and insert it into an air bag housing in a conventional way.

The present invention proposes to fold a toroidal air bag in an arbitrary or chaotic manner but to insert this folded air bag into the cover, and to use a piston coaxially aligned with a ram plate in the folding shape within the apparatus to dispose the folded cushion in a toroidal module. Disclosed is a simple means of folding an air bag and does so in an ergonomic manner offering greater efficiencies. It is an object of the present invention to provide an apparatus for folding an air bag that is convenient to use.

Accordingly, the invention comprises a folding apparatus for inserting an air bag into an interior cavity of a cover. In the preferred embodiment, the air bag is attached to a cushion retainer and inflator before it is inserted into the cover. The apparatus comprises a straight tube, the tube sized in cross-section to slidably receive a ram plate. The cross-section further is configured to substantially conform to the cross-section of an interior cavity defined by the module deployment cover. The tube includes a pair of open ends oriented so that a plane of the tube is substantially parallel to vertical although other configurations are within the scope of the invention. The folding apparatus includes a ram apparatus movable through the tube and adapted to hold and move a ram plate and air bag through the tube. When moved in one direction, the ram apparatus moves the air bag into the cover. The folding apparatus further contains a lower movable piston, which functions as an interior cushion support and is passed through a hole in the air bag module cover. The folding apparatus additionally includes a holding fixture for orienting the cover so that its internal cavity is in alignment with and adjacent to the tube such that the housing and air bag can be rammed into the cover internal cavity.

Many other objects and purposes of the invention will be clear from the following detailed description of the drawings.

### BRIEF DESCRIPTION OF THE DRAWINGS

FIG. 1 is an exploded view of a typical driver side air bag module;

FIG. 2 is a rear plan view of an assembled module;

FIG. 2A is a cross-sectional view of an assembled driver side air bag module through section line 2A-2A of FIG. 2;

FIG. 2B is a diagrammatic view of a neck portion of an air bag;

FIG. 3 is a diagrammatic view of the major components of a folding apparatus;

FIG. 4 is a diagrammatic view of a tube component according to the teachings of the present invention;

FIG. 5 is a perspective view of the first end of the tube according to the teachings of the present invention;

FIG. 6 is a perspective view of a second end of the tube according to the teachings of the present invention;

FIG. 7 is a perspective view of the ram according to the teachings of the present invention;

FIG. 8 is an end view of the ram plate according to the teachings of the present invention;

FIG. 9 is a perspective view of the piston according to the teachings of the present invention;

FIG. 10 is a top perspective view of the piston according to the teachings of the present invention;

FIG. 11 is a top perspective view of the cover holding fixture according to the teachings of the present invention;

FIG. 12 is a top view of the fixture according to FIG. 11 holding an air bag cover;

FIG. 13 depicts a coupling of a module cushion retaining member to the piston;

FIG. 14 describes coupling a cushion over the piston and cushion retaining member;

FIG. 15 depicts the disposing of an air bag inflator within the cushion and onto the cushion retaining member;

FIG. 16 depicts the coupling of the ram onto the mounting plate;

FIG. 17 depicts the positioning of the tube around the cushion, ram subassembly;

FIG. 18 depicts the coupling of the tube and piston to the fixture;

FIG. 19 depicts the side close-up view of the tube coupled to the fixture;

FIG. 20 shows the compression of the cushion into the cover;

FIG. 21 shows the ram disposed within the cover according to the teachings of the present invention;

FIG. 22 represents the bottom view of the fixture containing a module having a cushion disposed therein;

FIG. 23 depicts a folding cushion after the ram is removed;

FIG. 24 depicts removal of a pair of cover retaining apparatus;

FIG. 25 depicts a coupling of a cover flange over the retaining studs; and

FIG. 26 depicts the coupling of the module housing to the cover/cushion subassembly.

### DETAILED DESCRIPTION OF THE DRAWINGS

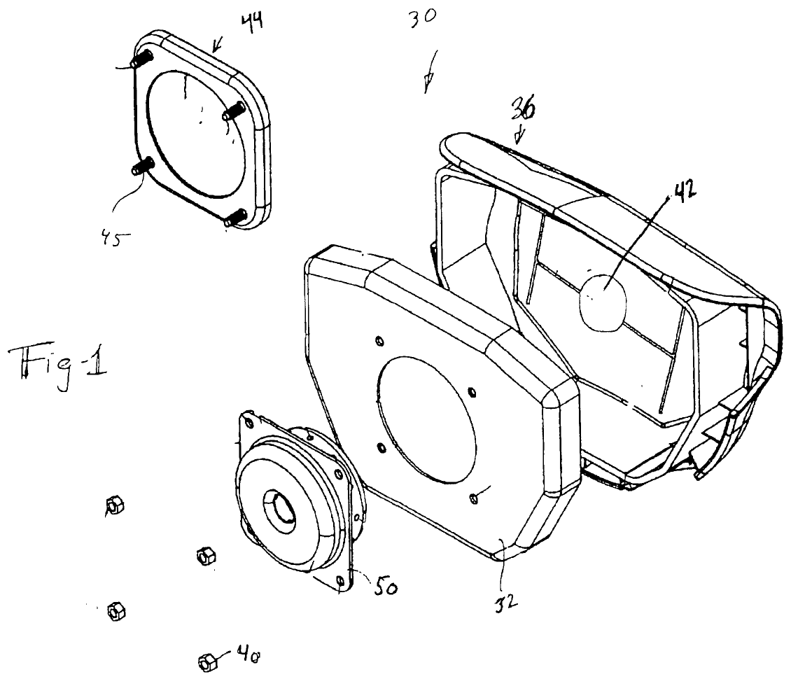

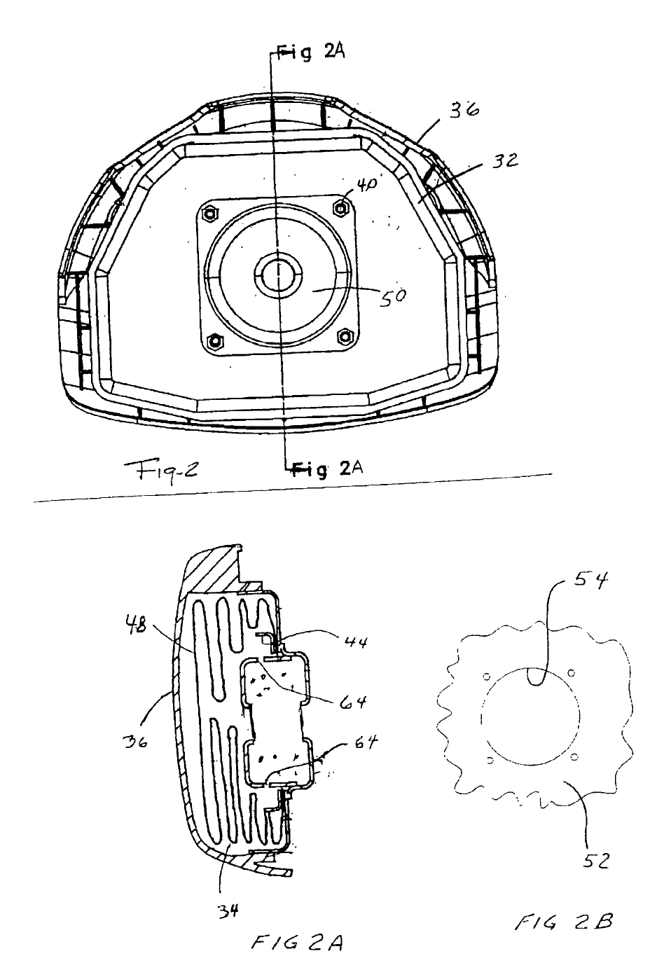

Referring generally to FIGS. 1 through 2B, an air bag module 30 is shown. The air bag module 30 includes a housing 32 coupled to a steering wheel armature 34. A cover 36 is retained by either the housing 32 or the steering wheel armature 38 utilizing standard fasteners 40. The retainer 44 functions to hold electronic components at a surface 46 of the cover 36. Additionally, the retainer 44 functions as a bracket to hold the toroidal air bag 48 and inflator 50 within the module 30. The toroidal air bag and inflator are coupled to the housing 32 of air bag module 30 using standard coupling studs 45 on the cushion retainer 44.

The cover 36 is generally made from thermoplastic olefin or a thermoplastic elastomer, and has a plurality of retaining apertures 34, which are used to couple the cover 36 to the mounting plate 12. The cover 36 defines a central aperture 42, which is used to expose an air bag retainer 44 disposed within the module 30 and a cover cavity 43.

The toroidal air bag 48 has an internal neck portion 52 with a central opening 54 and a plurality of openings 56, which are used to couple the toroidal air bag 48 to retainer 44. Inflator 50 comprises a mounting flange 58 with a plurality of mounting openings 60. The inflator 50 includes a body 62 in which propellant and/or inflation gas is located and the body has at least one but usually includes a plurality of exit ports 64.

As previously indicated, a typical way of assembling an air bag module 30 is to insert the retainer (retaining ring) within the central opening 64 of the air bag 48 and then to carefully fold the air bag. Thereafter, an optional fabric or paper covering (such as Tyvek®) may be used to envelop the folded cushion to maintain the fold during the subsequent handling of the folded bag. Thereafter, the folded air bag is inserted into the housing. Subsequently, the cover 36 is attached to the housing. Thereafter, the inflator is inserted and secured to the housing.

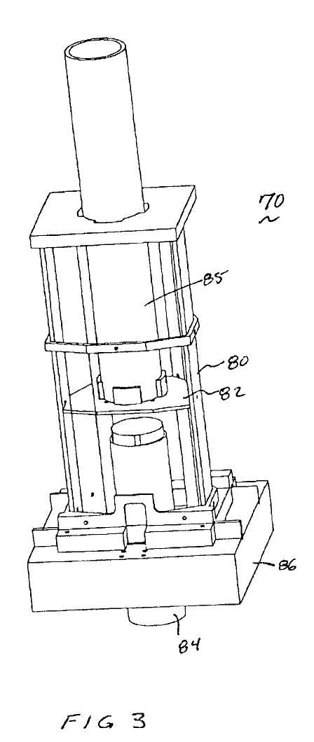

Reference is made to FIG. 3, which illustrates the folding apparatus 70, which is designed to compress and insert an air bag 48 within an interior cavity 72 of the cover 36. The cover 36 is typically formed of four walls 74, which surround an air bag cover door 76. In this regard, the door 76 has a defined through hole 78, which functions to accept the associated retainer as described in co-pending application Ser. No. 09/871,037, hereby incorporated by reference.

The folding apparatus 70 comprises a straight tube 80, a ram 82, a lower movable piston member 84, an upper movable piston member 85, and a base fixture 86. The tube 80 is preferably made of transparent LEXAN®, which will enable most folding operations to be visible by an attending operator.

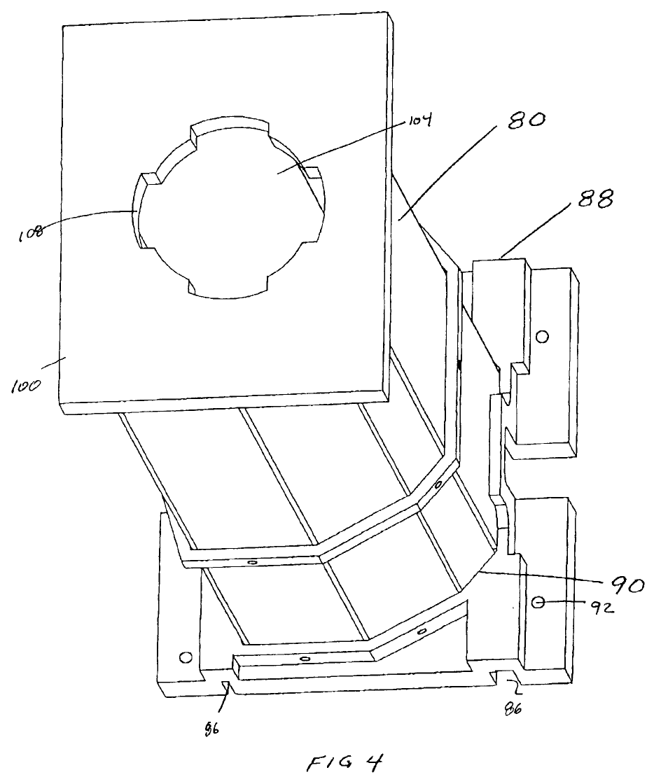

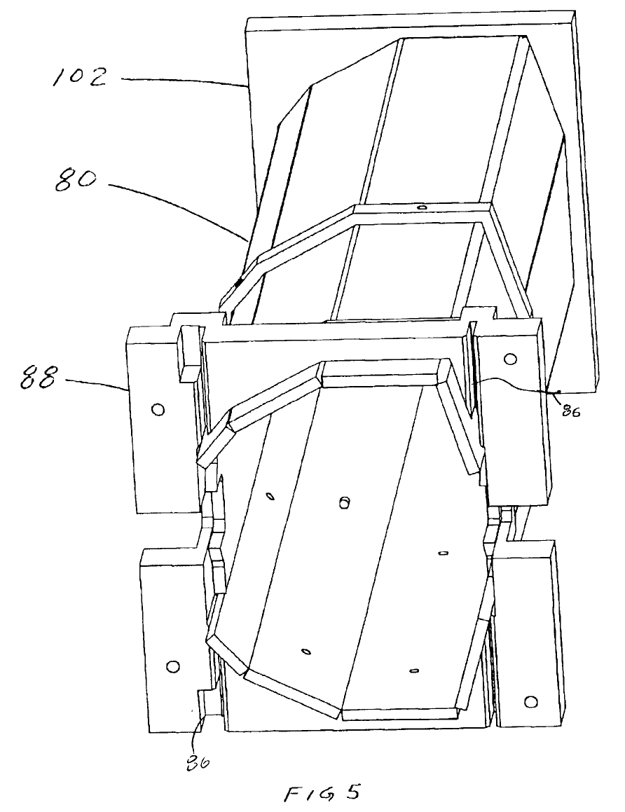

Reference is now made to FIGS. 4-6, which show the tube 80. The cross-section of the tube conforms to the cross-section of the cavity 72 of the module cover 36. The tube 80 defines a coupling structure 88 at its first end 90. The coupling structure 88 defines a plurality of holes 92 configured to accept pins 94 disposed on the fixture 86. Further defined on the coupling structure 88 is a pair of parallel slots 96, which accept a pair of separator plates 98 (as described later).

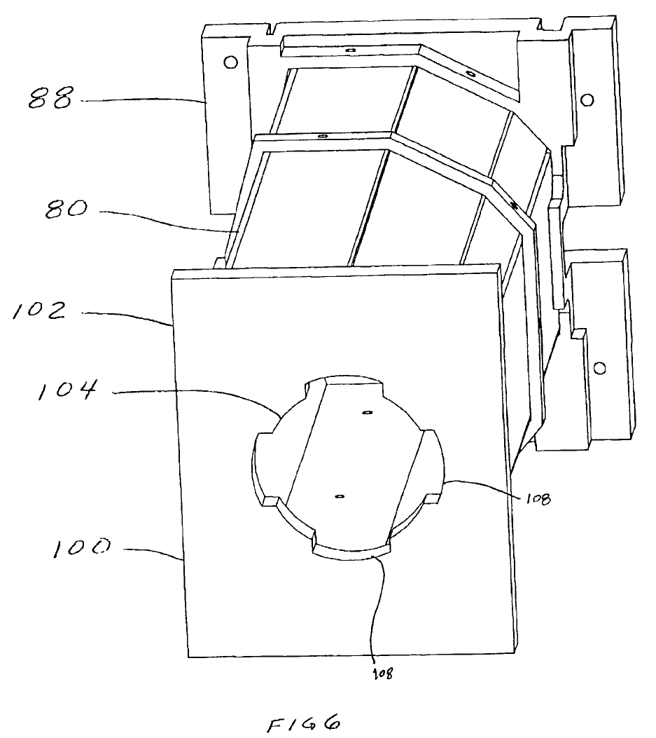

FIG. 6 depicts a perspective view of the second end 100 of the tube 80. Defined at the second end 100 is an end plate 102 with an orifice 104 configured to slidably accept the exterior surface 106 of the ram 82. Defined within the orifice 104 is a plurality of notches 108 configured to be mated with a plurality of flanges 110 disposed on the exterior surface 106 of the ram 82.

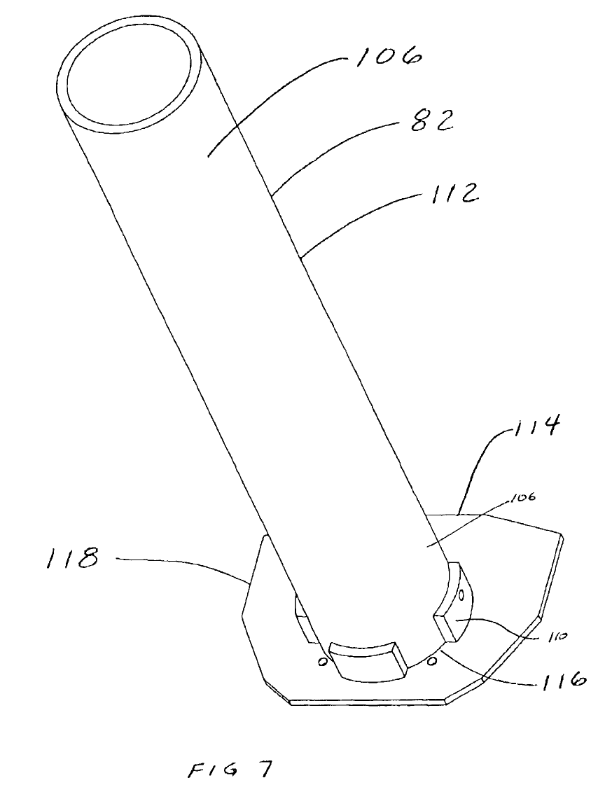

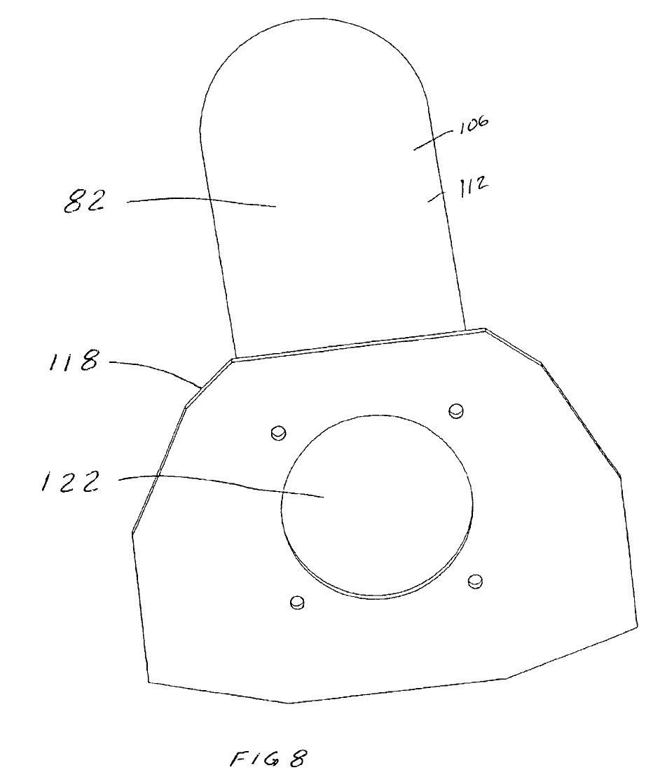

FIGS. 7 and 8 depict a perspective end view of the ram 82. The ram 82, which is configured to be moved through and out of the tube 80, is a generally cylindrical body 112 having a ram plate 114 disposed at one end 116. The ram plate 114 has an exterior periphery 118, which substantially conforms to the interior cross-section 120 of the tube 80. Disposed on the exterior surface 106 of the ram 82 is a plurality of flanges 110, which mate with the notches 108 defined in the orifice 104 of the end plate 102. The notches 108 and flanges 110 allow the full retraction of the ram plate 114 within the tube 80. FIG. 8 depicts an end view of the ram 82. As can be seen, the ram plate 114 defines an inner bore 122, which substantially conforms to the exterior surface 106 of the ram 82. The ram plate 114 is coupled to the ram body 112 by use of through fasteners 124, which couple the ram plate 114 to the flanges 110 defined at the end of the tubular body. Defined at the end of the ram body 112 is a plurality of cutouts 126 whose function is described below.

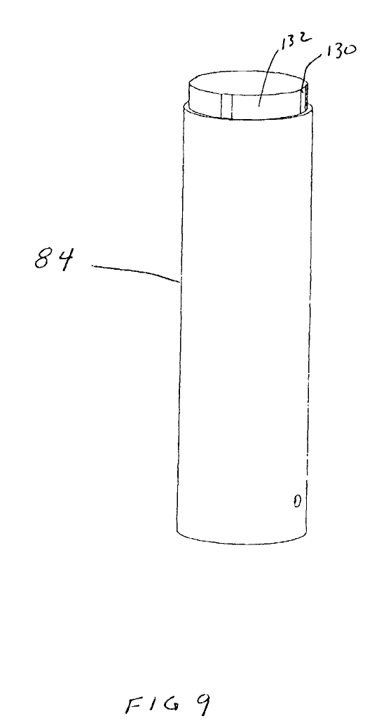

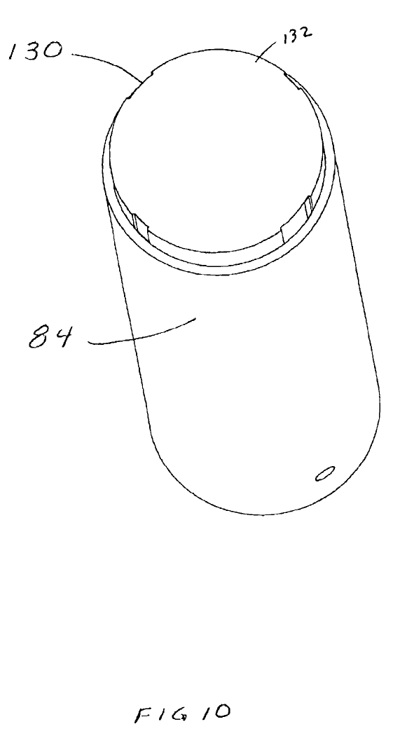

FIGS. 9 and 10 represent the piston member 84. The piston member 84 is a member that is slidably received through the hole 78 defined in the fixture 86 and through hole 78 of cover 36. Defined at the first end 128 of the piston 84 is a plurality of notches 130, which slidably couple with the retainer 44 of the module 30. In this regard, the exterior periphery 132 of the first end 128 substantially conforms to the interior surface 134 of the retainer 44.

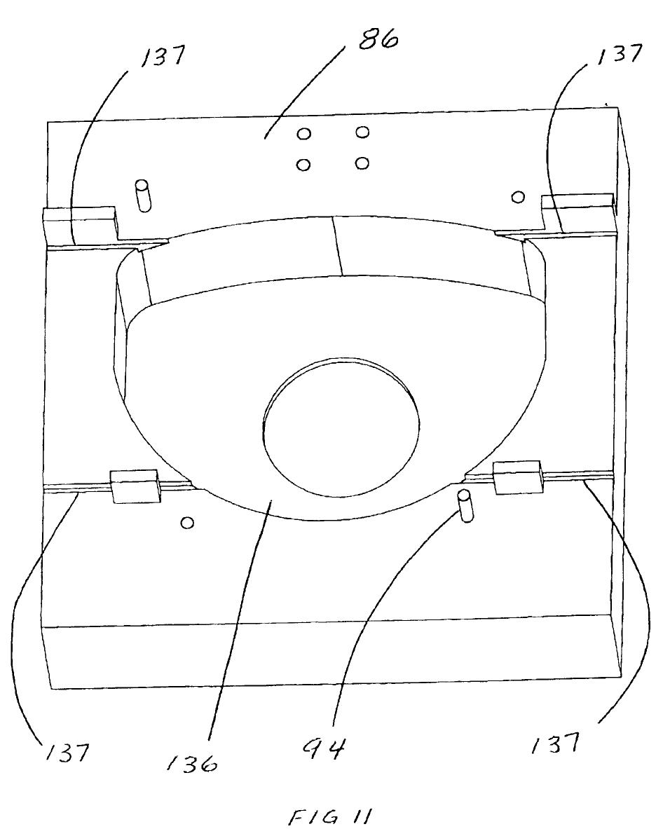

FIG. 11 depicts a top view of the fixture. Shown defined within the fixture 86 is a cavity 136, which conforms to the shape of the module cover 36. Further defined within the fixture 86 are a second pair of parallel slots 137, which are configured to be aligned with the slots 96 defined on the mounting assembly of the tube 80.

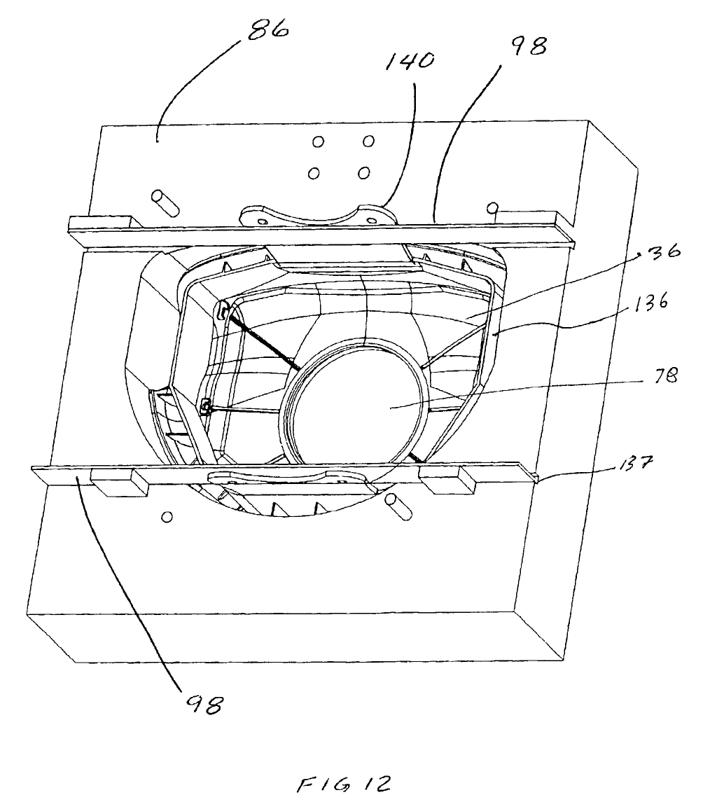

FIGS. 12-25 represent the methods associated with the assembly of an air bag module 30 according to the teachings of the present invention. FIG. 12 depicts the insertion of the cover 36 within the fixture 86. A pair of separator plates 98 is disposed within the slots 137 of the fixture 86. As can be seen, the separator plates 98 function to hold the cover 36 within the cavity 136 as well as to hold the pair of retaining flanges 140 of the cover 30 in a position that allows for the insertion of the toroidal air bag 48.

As can be seen, the through-hole 78 defined through the cover 36 and the fixture 86 are coaxial and have substantially the same radius. These both function to slidably accept the piston member 84, as will be further described below.

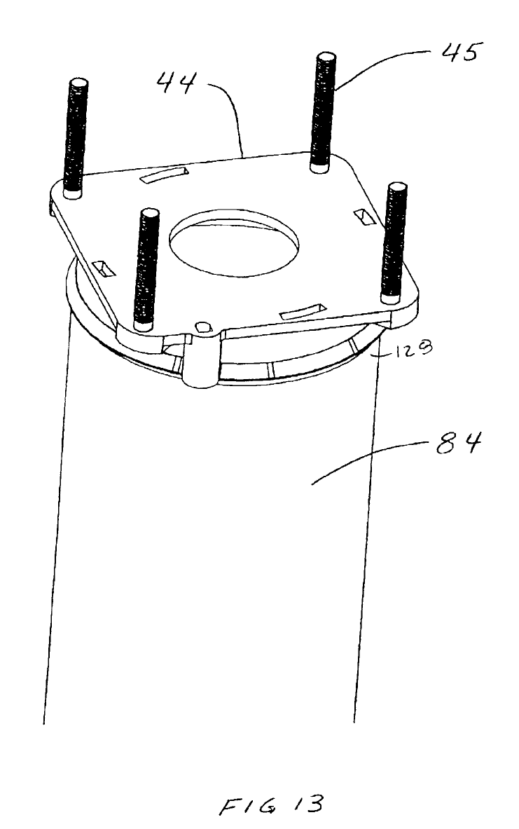

FIG. 13 depicts the mounting of the retainer 44 onto the first end 128 of the piston 84. The notches 130 of the first end 128 (see FIG. 9) are interleaved with the corresponding notches defined on the interior 134 of the retainer 44. As can be seen, the retainer 44 has four mounting studs 45, which are used to couple the toroidal air bag 48 and couple it to the module 30.

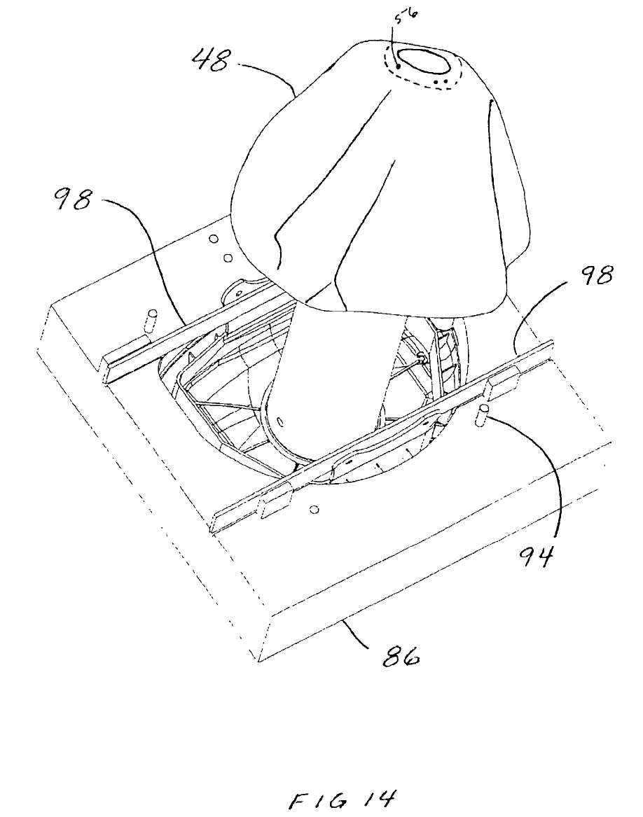

FIG. 14 depicts the positioning of the toroidal air bag 48 over the piston 84. In this regard, the internal neck portion 52 of the toroidal air bag 48 is annularly disposed over and around the piston 84. The retaining studs 45 of the retainer 44 are positioned through the holes 56 of the toroidal air bag 48, encasing the retainer 44 within the interior neck portion 52. The piston 84 is positioned within the hole 78 defined by the fixture 86 and cover 36.

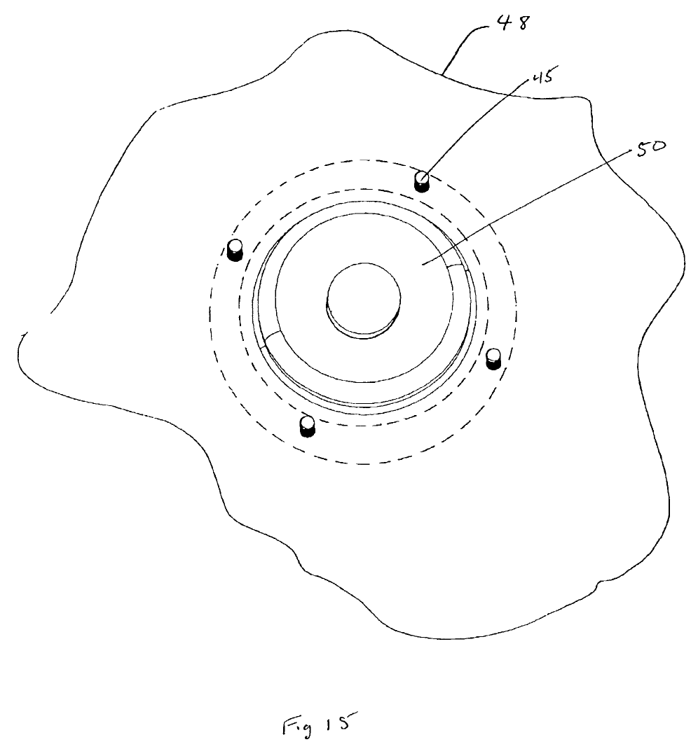

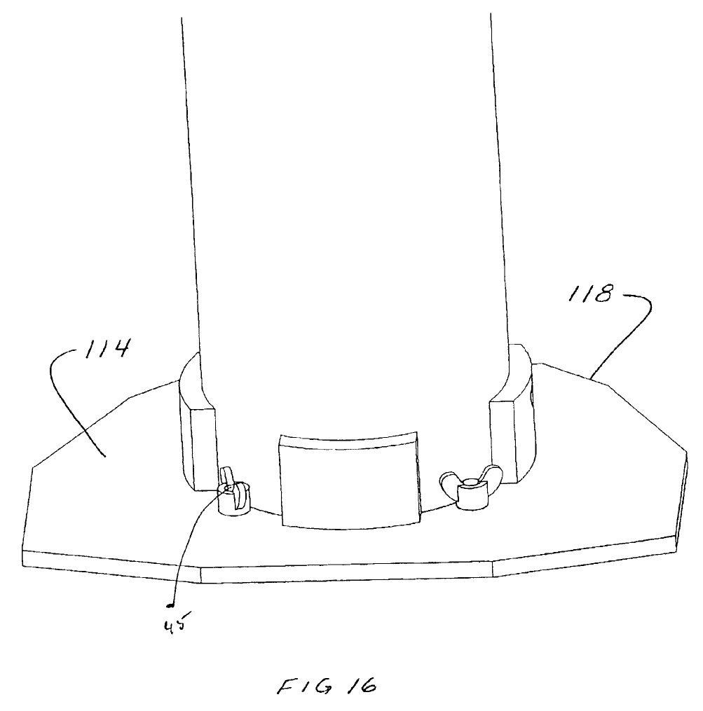

FIG. 15 depicts the insertion of the module inflator within the cushion. The studs 45 are positioned through a second set of four holes disposed within the body of the toroidal cushion 48. FIG. 16 depicts the coupling of the ram 82 to the studs 45 of the retainer 44. While the ram plate 114 is shown being coupled to the studs 45 using wing nuts, it is envisioned that an automated system encompassing pneumatic controlled fasteners or clamps can be used.

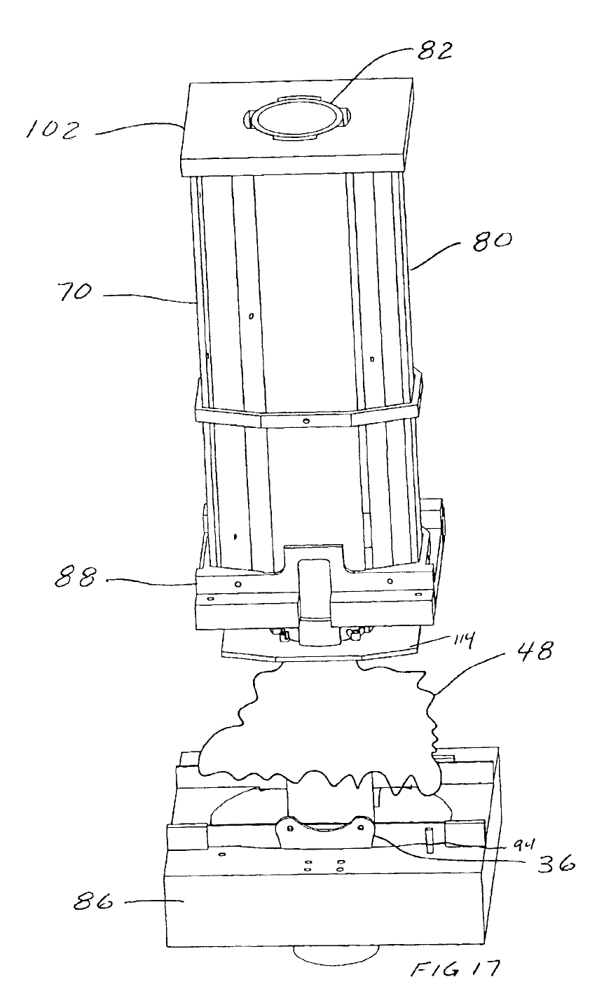

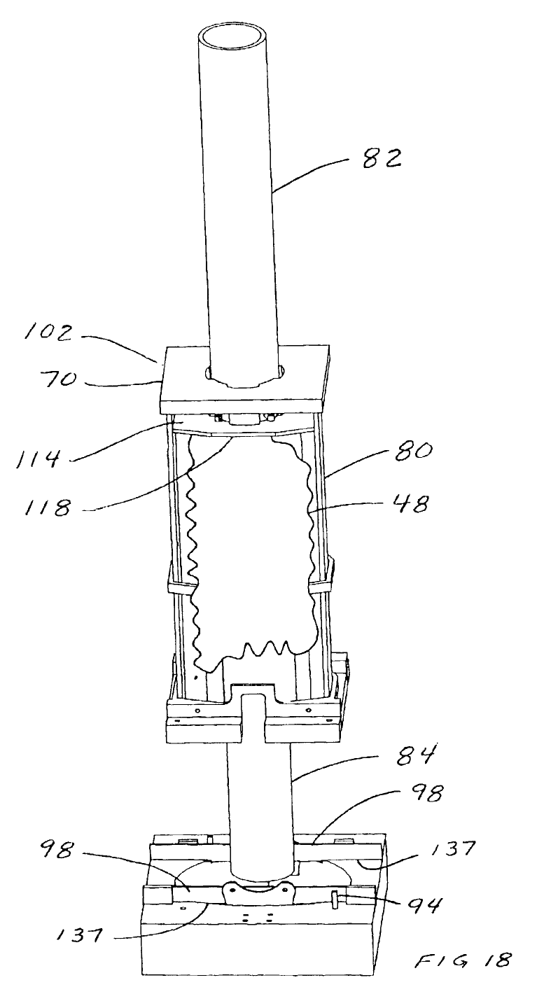

FIGS. 17 and 18 depict the positioning of the tube 80 over the ram 82, piston 84, and toroidal cushion 48. At this point, the tube 80 is brought into locking contact with the fixture 86 utilizing the pins 94. As best seen in FIG. 18, when the tube 80 is brought down onto the fixture 86, the ram plate 114 is held stationary and is positioned adjacent to the second end of the tube 80.

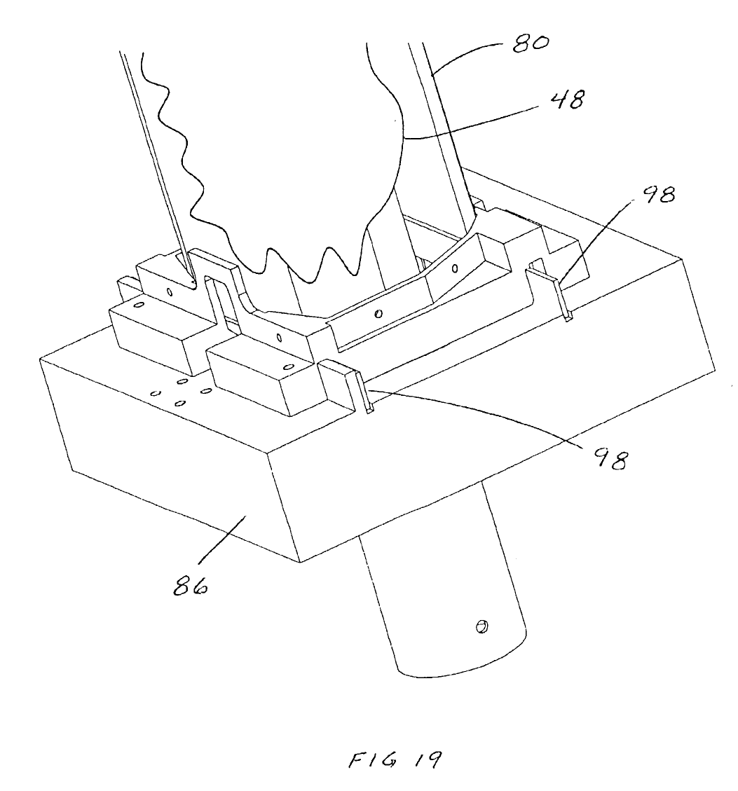

FIG. 19 depicts a close-up side view of the mating of the tube 80 with the fixture 86. Shown are the separating plates, which are used to place the air bag module cover 36 in its proper orientation.

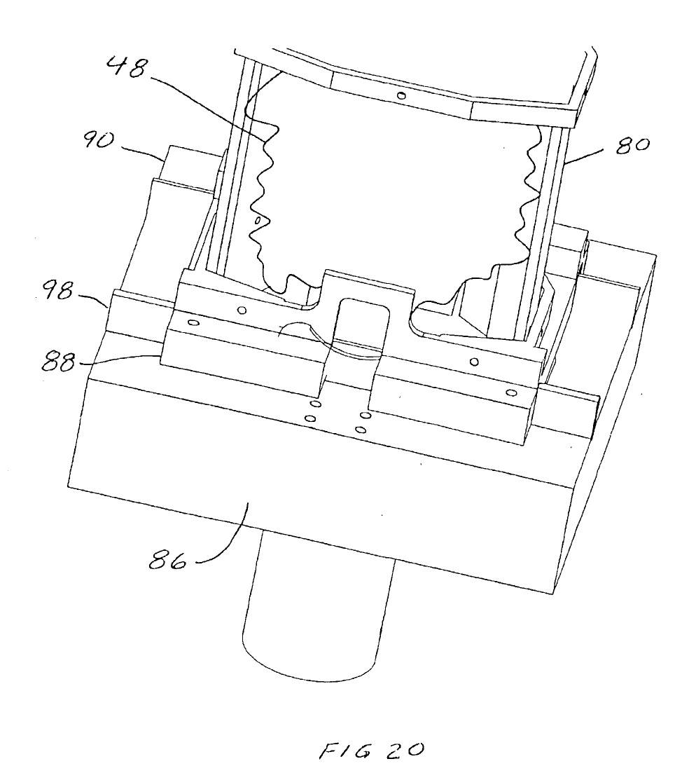

FIG. 20 depicts the pushing down of the ram 82 and piston 84 through the tube 80. As can be seen, the ram plate 114 forces the toroidal air bag 48 into the cavity 72 of the cover. Prior to allowing the ram plate 114 to move, the upper piston 85 is brought nearly into contact with the lower piston 84, so that the air bag 48 and retainer 44 are sandwiched between the two pistons. In this manner, the piston 84 prevents the toroidal air bag 48 from being extruded through the hole 78, while the piston 85 creates an inflator installation pocket within the scrunch folded cushion.

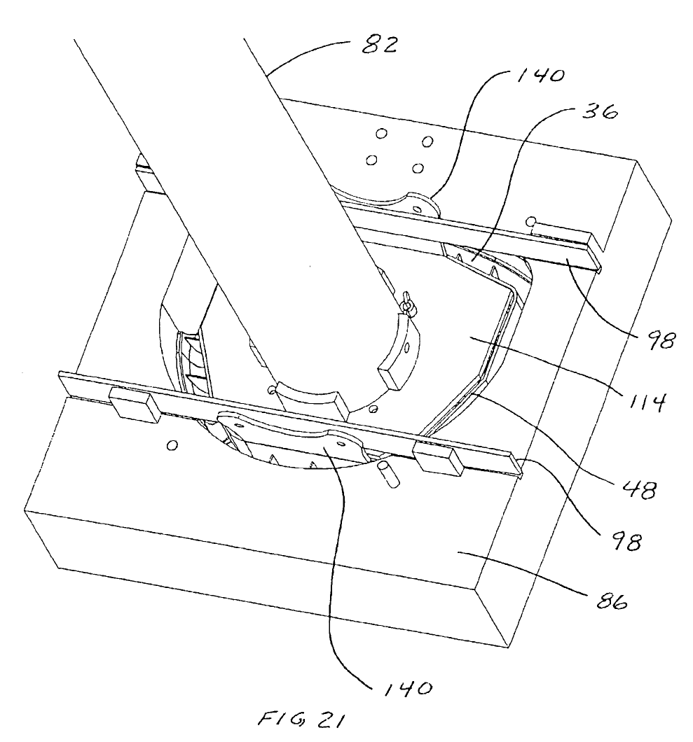

FIG. 21 depicts the toroidal air bag 48 folding assembly with the tube 80 removed. As can be seen, the toroidal air bag 48 has been compressed within the cavity of the module cover 36 and the ram plate 114 is forcing the cushion within the cover 36. As can be seen, the folded air bag 48 is annularly disposed about the retainer 44.

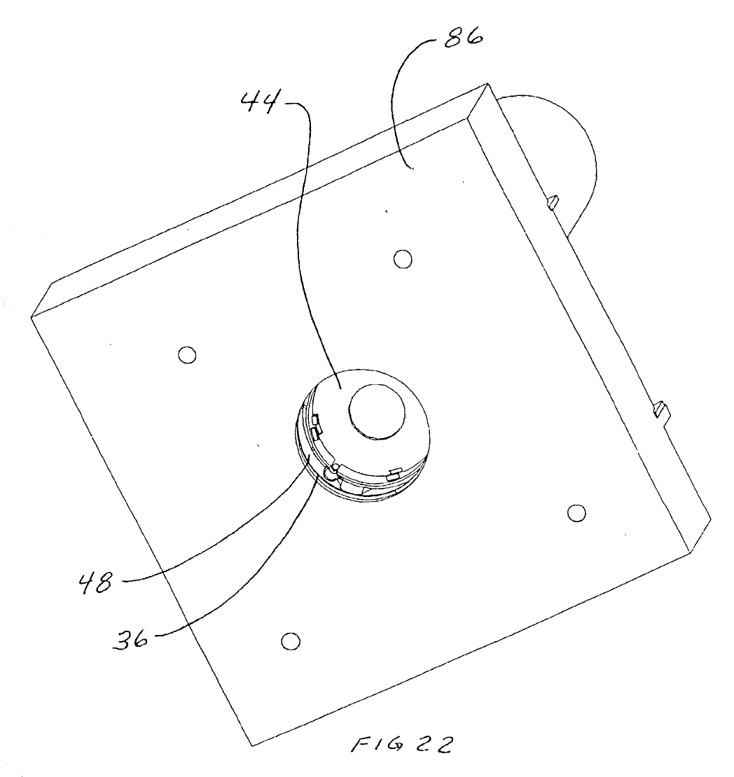

FIG. 22 depicts a bottom view of the cushion folding mechanism. As can be seen, the piston 84 becomes detached from the retainer 44, leaving the hole defined by the fixture empty. It is envisioned the piston can be actuated up through the hole pneumatically after the module assembly 30 has been removed from the fixture 86.

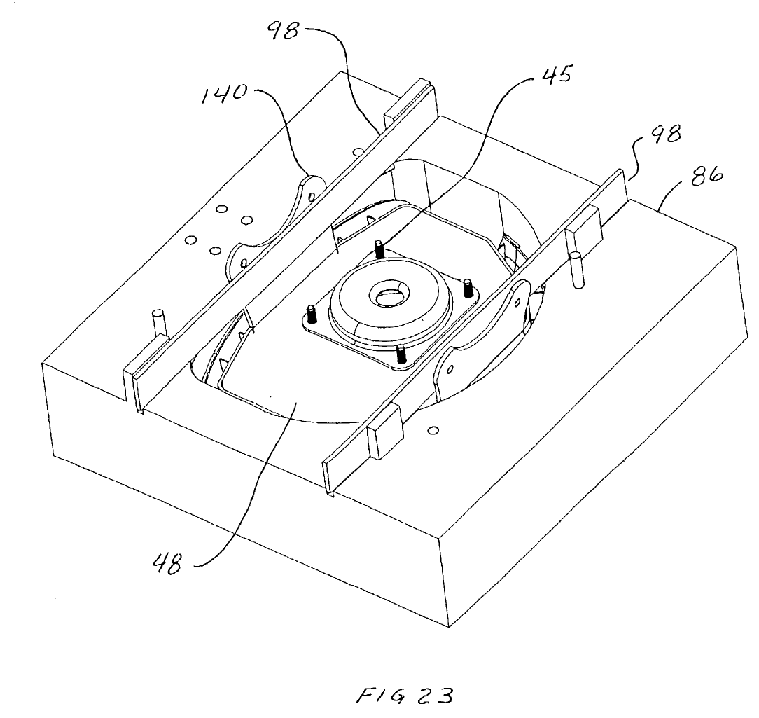

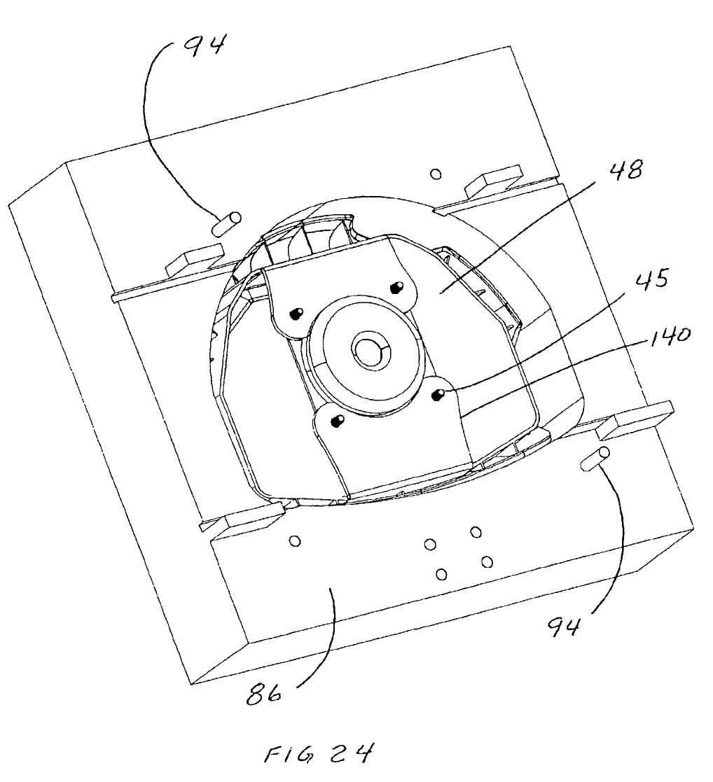

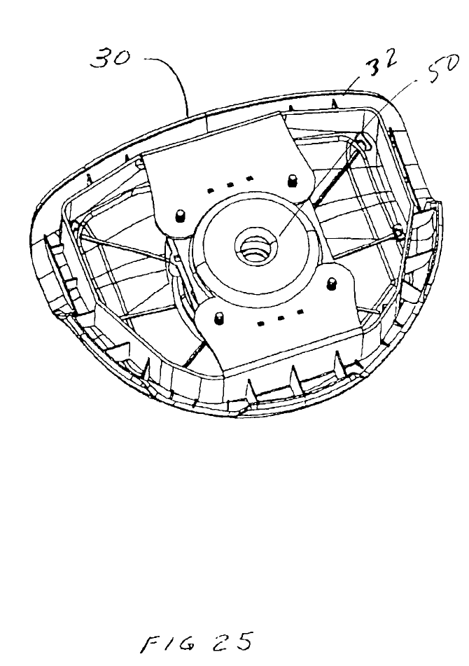

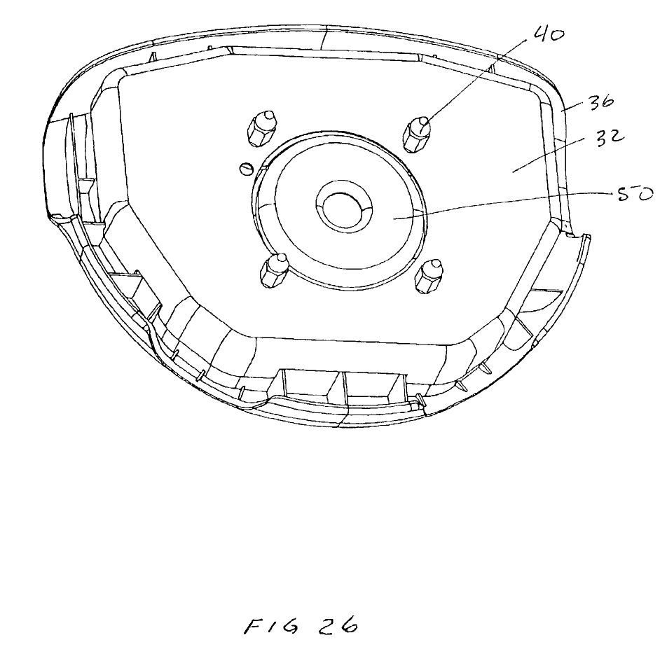

FIG. 23 shows the module assembly after the ram has been removed from the mounting studs. As can be seen, the separator plates hold the flanges of the cover away from the mounting studs. FIG. 24 depicts the cover flanges being disposed over the mounting studs after the separator plates have been removed. FIG. 25 shows the positioning of the cover flanges over the studs of retainer 44. FIG. 26 depicts the coupling of the housing base plate onto the module.

Many changes and modifications in the above-described embodiment of the invention can, of course, be carried out without departing from the scope thereof. Accordingly, that scope is intended to be limited only by the scope of the appended claims.

1. A folding apparatus for inserting an air bag into an interior cavity of a cover defining an axial hole, the apparatus comprising:
a tube (80), the tube (80) sized to permit the air bag (48) to be drawn up into the tube (80), the tube (80) including an open first end oriented so that a plane through the first end is at a desired orientation;
a ram (112) movable through the tube (80) for holding and moving the air bag (48) through the tube (80);
a piston (84) disposed through said hole and coaxially coupled to the ram (112);
a fixture (86) for orienting a cover (36) so that its internal cavity is in alignment with and adjacent to the first end such that the air bag (48) can be rammed into the cover cavity (43); and
a piston (84) disposed through a hole (78) in said fixture coaxial to the ram.

2. The apparatus as defined in claim 1 wherein the ram (112) comprises a ram plate (114) that is movable along an axial direction.

3. The apparatus as defined in claim 1 wherein the ram (112) is movable through and out of the tube (80) to a position convenient for the user of the apparatus to install and dismount the air bag (48) onto and off from the ram (112).

4. The apparatus as defined in claim 1 wherein the air bag (48) is rammed directly into the cavity (47) of the cover (36).

5. The apparatus as defined in claim 1 wherein the piston (84) is configured to mate with a retainer (44).

6. The apparatus as defined in claim 5 wherein the retainer (44) comprises a plurality of fasteners (45), and wherein the air bag (48) is coupled to said fasteners (45).

7. The apparatus as defined in claim 5 wherein the retainer (44) defines an interior surface configured to couple to the piston (84).

8. The apparatus as defined in claim 5 wherein the retainer (44) is disposed between the ram (112) and the piston (84).

9. The apparatus as defined in claim 5 wherein the ram plate (114) defines an exterior periphery which substantially conforms to a cross-section of the tube (80).

10. The apparatus as defined in claim 5 wherein the ram (112) is coupled to the retainer (44).

11. The apparatus as defined in claim 2 wherein the ram plate (114) is slidably movable from a first position relative to the tube (80), to a second position such that the air bag (48) is positioned within said cover (36) and the ram plate (114) is disposed adjacent the cover (36) such that if the cover (36) were attached to the ram plate (114) the cover (36) would lie substantially horizontal at the second orientation.

12. The apparatus as defined in claim 1 wherein the fixture defines a hole (78) coaxial with the hole (86) defined by the cover (36).

13. The apparatus as defined in claim 12 wherein the hole (78) is configured to receive the piston (84).

14. The apparatus as defined in claim 1 further comprising a pair of retention plates (98) configured to hold the cover (36) to the fixture (86).
